(19) United States
(12) Patent Application Publication
(10) Pub. No.: US 2022/0260387 A1
(43) Pub. Date: Aug. 18, 2022

(54) A SYSTEM AND METHOD FOR PROPHYLACTIC MITIGATION OF VEHICLE IMPACT DAMAGE

(71) Applicant: Assess Threat PTY LTD, Redfem (AU)

(72) Inventors: Aaron Vihao Tran, Redfern (AU); Henry Cao Zhong, Redfern (AU)

(21) Appl. No.: 17/624,820

(22) PCT Filed: Jul. 6, 2020
(86) PCT No.: PCT/AU2020/050709

§ 371 Date: Jan. 4, 2022

(30) Foreign Application Priority Data
Jul. 5, 2019 (AU) 2019902402

(51) Int. Cl. G01C 21/00

(52) U.S. Cl. CPC G01C 21/3852; G01C 21/387; G01C 21/3822

(57) ABSTRACT

A computing system for modelling momentum of vehicles inbound to a target location is described. The computing system includes a location engine for entering location data for the target location; a pathway engine configured to receive the location data and configured to develop vehicle pathway data for a plurality of suitable vehicle pathways from adjacent areas to the target location; a modelling engine configured to model vehicle momentum vector data for vehicles travelling along the vehicle pathways; a display engine for displaying the results of the modelling engine There is also described a method of modelling momentum of vehicles inbound to a target location, the method including the steps of: receiving location data into a computer processing system, which relates to a target location relevant to vehicle travel; generating pathway data in a computer processing system, relating to one or more vehicle pathways to the target location from adjacent areas, generating modelling data in a computer processing system relating to momentum of vehicles travelling along the one or more pathways to the target location; displaying on a computing device the output of the modelling data.

### TECHNICAL FIELD

The present technology relates generally to a system and method for modelling potential vehicle behaviour in relation to a selected target property or location and mitigating potential impact damage to the target from one or more vehicle impact pathways.

### BACKGROUND

There are known methods of modelling vehicle behaviour relative to targets. The most common method involves, as a first step, visual inspection of maps to manually identify possible paths and routes to a target. Once possible paths have been identified, a practitioner will either estimate the potential speed of an incoming vehicle using their own expertise and judgment, or by making measurements on that map and then performing calculations manually. An example is shown in FIG. 1 which shows a screenshot of a results page of a system of predicting vehicle impact damage to a target or site. The system is qualitative and labour intensive and does not provide quantitative results or solutions.

Another known method is Vehicle Swept Path Analysis (VSPA) software. VSPA is a type of Computer Assisted Design (CAD) or Finite Element Analysis (FEA) software that allow users to model and similar vehicle behaviour across a single selected path. It is primarily used for planning and design of roads, parking areas and bays and the like. It is not typically used for assessing exposure to hostile vehicles, or even vehicle dynamics on dangerous roads. Whilst VSPA software allows the user to perform detailed and complex modelling of vehicles travelling along a path, the entire process of analysis is again manual and user driven, with the user required to manually upload maps of the area, manually identify and draw the expected pathways of inbound vehicles, and configure every vehicle characteristic, such as weight and like properties. A similar application is VAMPIRE® used for the rail industry, where the dynamics of rail vehicles are modelled, but only after suspension characteristics, rail profiles, mass, bogie configurations etc, are entered. Above all, it is fair to say that VSPA software is a specialized technical tool which requires significant expertise and experience to operate. An example screenshot output of VSPA is shown in FIG. 2.

Each one of these arrangements has limitations in its flexibility, long delivery times for results, and high threshold of assumed knowledge.

There is a significant cost to known systems because users of the system are required to have high technical knowledge. The known systems are also labour intensive and take a long time to arrive at high quality output and vehicle impact mitigation designs. Due to the manual nature of the known solutions, there is no ability to scale to larger tasks or more clients without significant investment in skilled labour in multiple locations around the world to reach those clients. There is no consistency in the results, since some practitioners utilise only their judgement.

The present inventors seek to ameliorate one or more of the abovementioned disadvantages, and/or at least provide a new alternative to known methods of modelling vehicle behaviour and impact damage in relation to a target or location.

### SUMMARY

Broadly, the present technology provides a computing system and a method for modelling momentum and impact vectors of vehicles inbound to a target or location. The system and method in some embodiments provides energy of impact at selected points along inbound pathways so as to identify the most efficient deployment regime of dissipation units such as bollards, screens and/or barriers and the like, and their size, type, mass, spacing, location and/or disposition.

Broadly, the present technology provides a system that, given a user-selected location, autonomously collects data relevant to vehicle movement towards that location and calculates vehicle pathway data to the location so as to identify and mitigate vehicle impact risks.

Broadly, the present technology provides a location-based mobile device application which is configured to receive target location data from a user, for example by being disposed at the target location, the mobile application further being configured to output vehicle momentum vector data and barrier location data. In arrangements, the application provides location data for location and disposition of vehicle barriers and other vehicle inhibitors, shown on a display screen of the mobile device and confirmed by locating the device on the proposed barrier location.

Advantageously the present technology provides vehicle momentum and impact data using location coordinate data, supplemented with other available data feeds relevant to the location.

In accordance with one aspect of the present technology there is provided a computing system for modelling momentum of vehicles inbound to a target location, the computing system including:
a location engine for entering location data for the target location;
a pathway engine configured to receive the location data and configured to develop vehicle pathway data for a plurality of suitable vehicle pathways from adjacent areas to the target location;
a modelling engine configured to model vehicle momentum vector data for vehicles travelling along the vehicle pathways;
a display engine for displaying the results of the modelling engine.

In accordance with another aspect of the present technology there is provided a method of modelling momentum of vehicles inbound to a target location, the method including the steps of:
receiving location data into a computer processing system, which relates to a target location relevant to vehicle travel;
generating pathway data in a computer processing system, relating to one or more vehicle pathways to the target location from adjacent areas,
generating modelling data in a computer processing system relating to momentum of vehicles travelling along the one or more pathways to the target location;
displaying on a computing device the output of the modelling data.

The arrangement is such that, in embodiments, the system and method provide a detailed analysis of a target location for vulnerability to vehicle attack, or for road safety problems by design or that develop over time, by finding and generating potential pathways for vehicle travel to a target location.

In one embodiment the only input required from a user to the computing system is location data relating to a selected target location. In one embodiment the system provides a map on a display screen so as to facilitate location data entry by a user. In one embodiment the system is responsive to touch data from a touch screen, on which a map is displayed. In one embodiment the system is responsive to mouse input data which may select a position on a displayed map, or input latitude and longitude coordinates into cells. In one embodiment, the system is responsive to voice input location data received by a microphone. In one embodiment the system is responsive to data input from an onboard GPS engine or onboard location engine, which may receive location data from local WiFi or Bluetooth beacons. In one embodiment, the location engine provides a map on a mobile device display, generated from data input by a local GPS engine and the user indicates with the mobile device display the target location, which may be at the place they are standing.

In one embodiment, in operation the location engine calls for and collects geographical data and other information from networked servers regarding the target location and surrounds. This other location information may be relevant to the realtime situation such as weather and traffic flow. The other location information may be long-term statistical analysis of real-time data, including weather and traffic flow. The geographical data and other information may relate to local pathways including roads, highways, pedestrian walkways, sidewalks, bridges, tunnels, bicycle paths and so on, as well as local structures including trees, power poles, terrain and ground contours, sewage and drainage.

The location engine may also receive data from police crime databases such as for example, in New South Wales, the Bureau of Crime Statistics and Research (BOCSAR) database, and other insurance databases, to provide more insight on likelihood of aberrant vehicle behaviour.

The geographical data and other information may be in operation interpreted by image processing engines, using image data from satellite, drone, aerial and other image feeds relating to the location.

In one embodiment the location engine, using the one or more image processing engines, filters and enhances the image data to provide consistency for analysis by the pathway and modelling engines.

In one embodiment, the pathway engine receives the enhanced data from the location engine and generates one or more pathways, likely and/or possible, for vehicles in and toward the target location.

In one embodiment the pathway engine generates the one or more pathways using an algorithm. In one embodiment the algorithm receives the geographical data and other information and the image processing data and generates the vehicle pathway data using numerical and/or FEA principles. That is, it divides up the enhanced satellite or other aerial images in the adjacent area into small area elements and interprets and identifies connected areas on the same or similar elevation above mean sea level, or that are not impeded by trees or power poles, buildings, existing bollards, fences, or gutters and the like.

In use, individual small area elements containing portions of different visual features on the enhanced images may be interpreted differently by the pathway engine. That is, in use the pathway generator assigns each element a pathway allowance function, a pathway blocking function and/or assigns physical characteristics to those elements. For example, a brick building is assigned a pathway blocking function and a selected compression and tensile strength and those characteristics for that wall are input into a model for processing.

The pathway engine is configured to assign friction characteristics to some elements for input to a pathway model.

The pathway engine is configured to modify the friction characteristics to some elements dependent on input from some sources such as weather satellites, either in real time or using long-term statistical weather data.

In one embodiment the modelling engine includes a vehicle modelling engine which is configured to assign vehicle characteristics to moving elements such as for example mass, suspension stiffness and arrangement, tyre arrangement, speed, acceleration, and size.

In one embodiment the modelling engine assigns characteristics of the one or more pathways from adjacent areas to the target location, the pathway characteristics including distance, angle of turns, and the like.

In one embodiment the modelling engine assigns characteristics to the one or more pathways such as traffic congestion, weather, road type, road condition and the like.

In one embodiment the system also includes a barrier design engine which is configured to match vehicle impact results at locations along the one or more pathways with suitable barriers.

In one embodiment the barrier design engine is configured to provide locations and disposition of the selected barriers.

In one embodiment the barrier design engine provides directions on the mobile device to the designed location of the barrier.

In one embodiment the barrier design engine provides output of the location of designed barriers on a map which is displayed on the mobile device screen.

In one embodiment the system includes an ordering engine which is configured to place an order with a barrier supplier or a barrier warehouse.

In one embodiment the ordering engine is configured to debit a bank or credit card account.

In one embodiment the method includes the step of autonomously selecting one or more barriers and placing their proposed locations and dispositions on a map displayed on a screen of a mobile device.

In one embodiment the design engine sorts the results of the design decisions into a list of worst impacts and most efficient barrier deployments for action by a user.

In one embodiment there is the step of receiving road and other data environmental data from online databases relating to the target location.

In one embodiment there is the step of requesting and receiving building envelope data, to assess pathway width and other road characteristic data from online and local databases.

In one embodiment there is the step of providing additional road node data on any pathway to the target, wherein the road nodes are no more than a selected distance apart.

In one embodiment there is the step of requesting the selected road node distance from a user.

In one embodiment there is the step of using an iterative process to compute the distance and azimuth between two nodes i and j, wherein if the distance between two nodes i and j exceeds the set threshold d, an extra node k₁ is inserted d metres from i in the direction specified by the azimuth.

In one embodiment there is the step of iterating the insertion of new nodes until the provision of node kₙ, such that the distance between i and kₙ exceeds the distance between i and j.

In one embodiment the step of identifying cleaned GPS road nodes that are adjacent to one another, to generate one or more road node pathways to the target.

In one embodiment there is the step of requesting a radius around the target for analysis.

In one embodiment there is the step of generating pathways to the target within the selected radius.

In one embodiment there is the step of receiving user-input manual pathways to supplement the pathway generation step.

In one embodiment there is the further including the step of manually inputting traffic control devices using a device insertion tool on a GUI disposed on a display.

In one embodiment there is the step of requesting vehicle characteristic data either from a user or a database for analysis and prediction of vehicle behaviour along one or more pathways to the target.

In one embodiment there is the step of selecting pathway coordinate data set for one pathway and then, using the vehicle characteristic data, numerically modelling a plurality of different vehicle trips along the pathway to the target.

In one embodiment there is the step of calculating velocity of the modelled vehicle in each node using the formula

v_{f}=\sqrt{vᵢ²+(2ad)}

where a=aᵥ+aₛ
Where aᵥ=vehicle acceleration or deceleration in m/s²
aₛ=acceleration or deceleration due to slope in m/s²
Where aₛ=g×(sin(φ)+μ×cos (φ))
g=gravitational constant in m/s²
μ=friction coefficient
φ=angle of slope incline or decline in degrees
If φ represents an incline then
   aₛ will be negative, otherwise a positive value.

In one embodiment there is the step of estimating radius of a turn based on the following formula:

r=(pₐ×θ_{ifi}²)+(p_{b}×θ_{ifj})+p_{c}
Where r=radius of turn, and
pₐ, p_{b} and p_{c} are derived using a linear regression and
   θ_{ifj}=angle formed by a first node i, a final node f and node j (degrees) where 0≤θ_{ifj}≤180.

In one embodiment the linear regression involves fitting the curve radii and curve angle data from a road engineering and design standard.

In one embodiment there is the step of calculating maximum speed for a turn on the pathway.

In one embodiment there is the step of calculating the maximum speed for a turn on the pathway for each node using the equation is vᵢ=\sqrt{μrg}

where vₜ=maximum velocity for a turn (m/s)
μ=friction coefficient
g=gravitational constant (9.82 m/s2)
r=radius of the turn (m)

In one embodiment there is the step of taking the maximum velocity value for all node to node paths, comparing the initial velocity at the starting node i with the calculated maximum velocity for the turn, and then recording the lower of these two values as the maximum velocity for that path.

### Advantages

It can be seen that embodiments of the present technology provide a software application which connects geographical data and that which is available through online databases to perform vehicle vector analysis and make barrier design decisions in an automated manner with minimal manual steps or user input.

Further advantageously, embodiments of the system and method mitigate the need for users to perform manual tasks such as visually inspecting maps, identifying paths and performing momentum calculations. The method of at least some embodiments is also data-driven so it takes into account information and data that would not otherwise be considered such as weather and traffic congestion.

As a data-driven solution, embodiments also allow the system to provide more intelligent insights. For example, embodiments of the system know the speed of a vehicle at any point across the entirety of a path, so it can suggest an appropriate vehicle barrier at any point along the path and not just at the end of the path/point of impact. The system can therefore recommend where a lighter barrier would be effective in stopping a vehicle before it reaches a higher speed.

As an automated solution, embodiments can operate at a scale, speed and cost that cannot be matched using current methods which are manually performed.

In some embodiments the system and method advantageously predicts vehicle behaviours and potential damage to the target from one or more vehicle pathways so as to leave further decisions as to risk or damage mitigation to the user. In other embodiments the system and method takes further steps and suggests the most likely impact scenarios so as to leave certain mitigation decisions to the user. In other embodiments the system and method autonomously provides solutions to vehicle impact scenarios. In still other embodiments the system and method autonomously provides and ranks efficient solutions based on efficiency of outlay in terms of arrangement, cost and material.

In accordance with another aspect of the present invention there is provided a set of computing instructions provided over a computer network, the instructions to provide a method of modelling momentum of vehicles the steps including
receiving location data into a computer processing system, which relates to a target location relevant to vehicle travel;
generating pathway data in a computer processing system, relating to one or more vehicle pathways to the target location from adjacent areas,
generating modelling data in a computer processing system relating to momentum of vehicles travelling along the one or more pathways to the target location;
displaying on a computing device the output of the modelling data.

Clarifications

In this specification, where a document, act or item of knowledge is referred to or discussed, this reference or discussion is not an admission that the document, act or item of knowledge or any combination thereof was at the priority date:
(a) part of common general knowledge; or
(b) known to be relevant to an attempt to solve any problem with which this specification is concerned.

It is to be noted that, throughout the description and claims of this specification, the word ‘comprise’ and variations of the word, such as ‘comprising’ and ‘comprises’, is not intended to exclude other variants or additional components, integers or steps.

### BRIEF DESCRIPTION OF THE DRAWINGS

In order to enable a clearer understanding, a preferred embodiment of the technology will now be further explained and illustrated by reference to the accompanying drawings, in which:

FIG. 1 is a screenshot of a results page of a prior art system of predicting impact trajectory and target damage from vehicles;

FIG. 2 is a screenshot of an output of a prior art system of predicting impact trajectory of vehicles;

FIG. 3 is a schematic technical systems architecture of an embodiment of the computing system;

FIG. 4 is a flowchart showing functional steps taken by an embodiment of the system when in operation;

FIG. 5 is a visual representation of one type of transformation that one embodiment of the pathway engine undertakes, showing elements generated and analysed;

FIG. 6 is a main user interface of an embodiment of the system, the home screen of the user interface of the location engine, showing a GUI map which is configured to receive a target for vehicle attack analysis;

FIG. 7 is another portion of the user interface of the location engine in dark mode, which shows the user having manually input a path near a target, the manual path being into a building lobby or on a footpath, which is data not readily available from mapping software;

FIG. 8 is another portion of the user interface of the location engine, wherein the user is asked for certain configurations such as radius of analysis, and pathway node size;

FIG. 9 is another portion of the user interface, this time being the analysis engine, wherein the analysis engine requests the user enter vehicle configuration data;

FIG. 10 is another portion of the user interface of the analysis engine, wherein the engine asks for more vehicle data, this time for different vehicles;

FIG. 11 is the output from the analysis engine and barrier design engine, showing barrier design requirements for vehicle 1 shown being input in FIG. 9;

FIG. 12 is an output from the analysis engine and barrier design engine, showing quantitative outputs and qualitative outputs in the form of likelihood matrix and consequence matrix;

FIG. 13 is a heat map output showing high velocity potential areas for inbound vehicles; and

FIG. 14 is a results page on the UI, showing velocity graphs and energy and momentum graphs for a pathway output.

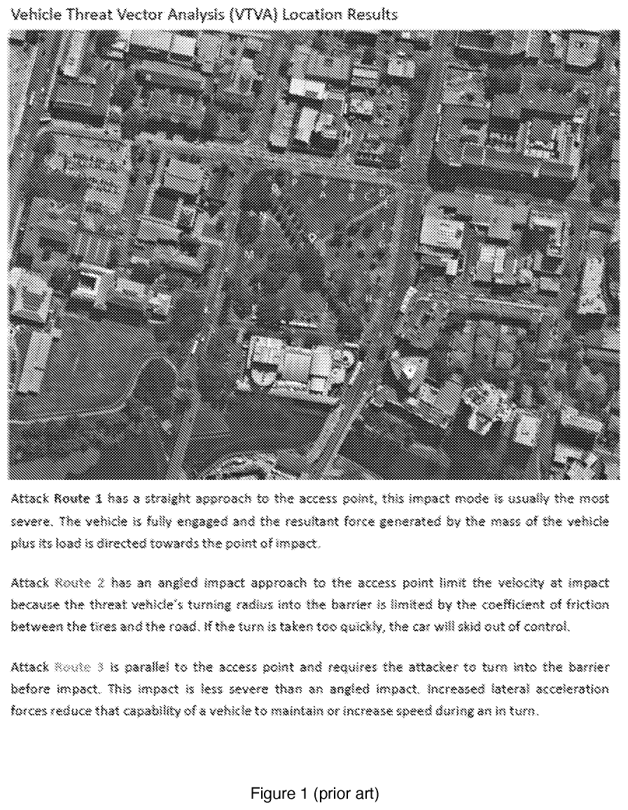

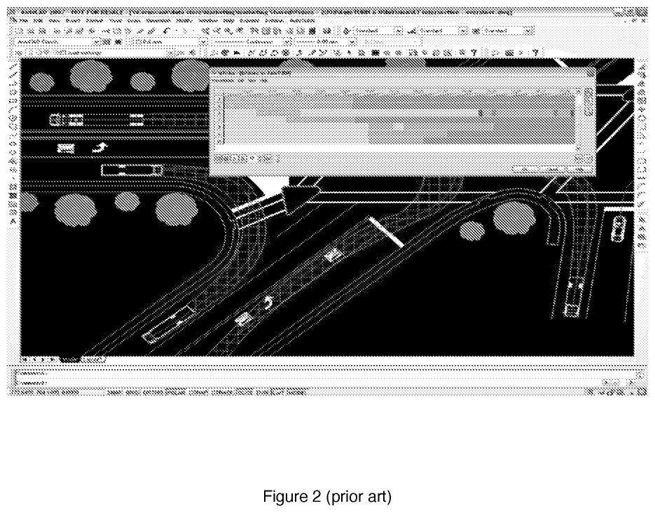

### DETAILED DESCRIPTION OF AN EXAMPLE EMBODIMENT

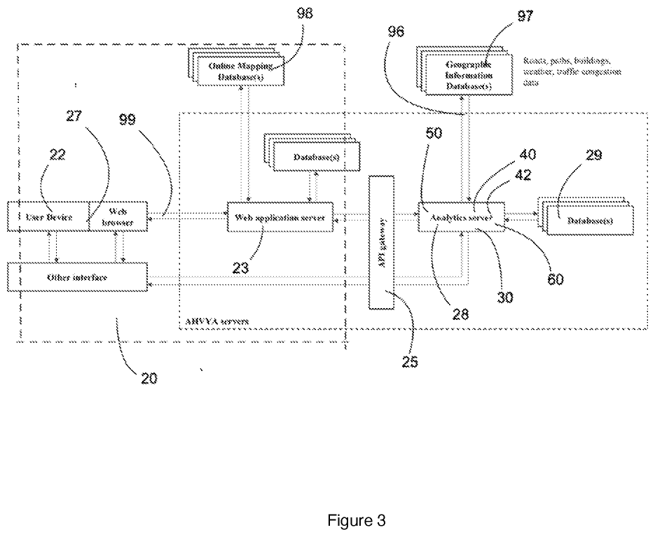

Referring to FIG. 3 there is shown an embodiment of a computing system generally indicated at 10. The system 10 is configured to model the momentum of vehicles inbound to a location (not shown) and includes: a location engine 20 for entering location data for the location, a pathway engine 30 configured to receive the location data and configured to develop vehicle pathway data for a plurality of suitable vehicle pathways from adjacent areas to the location; a modelling engine 40 configured to model vehicle momentum vector data for vehicles travelling along the vehicle pathways; and a display engine 50 for displaying the results of the modelling engine 40.

The arrangement of the system 10 is such that in operation it provides a detailed analysis of a location for vulnerability to vehicle attack, or for road safety problems by design or that develop over time, by finding and generating potential pathways for vehicle travel to a location.

The arrangement of the elements of the system 10 is such that in operation, substantially the only input required from a user to the computing system 10 is location data relating to a selected target location. This has clear advantages over known systems because the level of technical sophistication required of a user to be a competent designer of efficient barricades is low.

### Technical Systems Architecture

It can be seen that the location engine 20 in the embodiment shown is a sub-system which includes at least two computing devices, those devices including a user device 22 in the form of a mobile device such as for example a smartphone, and a web application server 23. The user device 22 is configured to operate a web browser on which the web application server 23 runs an application to provide a GUI on a display screen of the user device 22.

Thus, the location engine 20 in operation provides a GUI map on the display screen of the user device 22 so as to facilitate target 101 location data entry by the user. To commence barrier design, the user touches a relevant portion of the screen of the user device 22 which indicates a location and then location data of the location is input to a relevant portion of the device 22 and sent via a network 99 to an API gateway 25 and/or web application server 23.

The mobile device arrangement lends itself to providing realtime and immediate design of efficient barriers for police or security personnel or military personnel against vehicle intrusion to their location. Thus, the location engine 20 is operatively connected to, and responsive to, data input from an onboard GPS engine 27.

The location engine 20 further includes data connections to networked mapping servers 98 which themselves are configured to host up-to-date and historical filtered statistical data files regarding the target 101 location and surrounds.

Furthermore, the location engine 20 is operatively connected via a location engine analytics server 28, to another network 96, and via that network 96 also is configured to facilitate the collection of other location information from geographic information servers 97 which may be relevant to the real-time and historical situation of the target 101 location and surrounds. The geographic information servers 97 host other networked sites and include data relating to long, and short-term weather observations at a Bureau of Meteorology, traffic flow data at a Government or Private Roads Management Organisation, crime statistics at a government monitoring organisation such as BOCSAR and building data relating to their volume and construction materials at mapping sites.

Further geographical data and other information provided by other parties and available via API calls across the network 96 from the analytics server 28 or web application server 23 relate to local pathways including roads, highways, pedestrian walkways, sidewalks, bridges, tunnels, bicycle paths and so on, as well as local structures including trees, power poles, terrain and ground contours, sewage and drainage.

There is further provided as part of the system 10, an image processing engine 60 which is hosted by the analytics server 28 and which is configured to overlay and otherwise process geographical data and other information with image data of the target 101 location obtained from satellite, drone, aerial and other image feeds relating to the target 101 location. Thus, the image processing engine 60 in use filters and enhances the image data to provide consistency for analysis by the pathway and modelling engines.

The pathway engine 30 is hosted by the analytics server 28 and web application server 23. The analytics server 28 is connected to local databases 29 so it can access certain information that it has stored there. It is more efficient to store this information locally for input into pathway engine 30 algorithms, such as for example, certain physical properties of road elements, building elements, tree elements, and whether those elements allow or inhibit vehicles on a pathway to the target 101 zone. The analytics server 28 is connected to the user device 22 so as to output data relating to one or more relevant vehicle pathways that it generates, onto the map GUI. The connection between the analytics server 28 and the user device 22 is via the API gateway 25 so as to simplify the data connection and to facilitate access of the analytics server to sophisticated users who would like to create their own GUI and other analytics interfaces on user device 22. 89. In operation, it can be seen that the pathway engine 30 hosted on the analytics server 28 receives the enhanced data from the location engine 20 hosted on the web application server 23, and generates coordinate data for one or more pathways, likely and/or possible, for one or more potential vehicles having certain characteristics moving toward the target 101 location.

In more detail, the pathway engine 30 in operation generates data relating to the one or more pathways using an algorithm. The algorithm receives the geographical data and other information and image processing data from the location engine 20 hosted by the web application server 23 and local databases 24, and generates the vehicle pathway data using numerical and/or FEA principles. That is, the processor in the analytics server 28, guided by one or more algorithms, divides up the enhanced satellite or other aerial images in the adjacent map area into small area elements and interprets and identifies adjacent small areas on the map of same or similar elevation above mean sea level, or that are not impeded by trees or power poles, buildings, existing bollards, fences, or gutters and the like.

In operation, individual small area elements containing portions of different visual features on the enhanced images are interpreted differently by the pathway engine 30. That is, in use the pathway engine 30 assigns each element a pathway allowance characteristic, a pathway blocking characteristic and/or assigns physical characteristics to those elements. For example, a brick building is assigned a pathway blocking function and a selected compression and tensile strength and those characteristics for that wall are input into a pathway algorithm for processing. In addition, the pathway engine 30 is configured to assign friction characteristics to some elements for input to a pathway model and the modelling engine 40.

In addition, the pathway engine 30 is configured to apply a modification factor to the friction characteristics of some model elements, dependent on the networked input from some data sources such as for example weather satellites, either in real time, or using long-term statistical weather data stored locally or accessed by the network 96. 93. The modelling engine 40 is hosted on the analytics server 28 and includes a vehicle modelling engine 42 which is configured to assign vehicle characteristic data to vehicle model elements, the behaviour of which, when the system is in use, is modelled along a pathway toward a. The characteristic data are for example mass, suspension stiffness and arrangement, tyre arrangement, speed, acceleration, and size. This characteristic data is input into an overall friction factor for negotiating turns along a path toward the. The modelling engine 40 also is configured by its processor, which runs an algorithm discussed herein, to assign model characteristics to the one or more pathways such as traffic congestion, angle of turns, weather, road type, road condition and the like. The modelling engine 40 then in use provides vehicle momentum data for each cleaned node output to the GUI and displays it on the user device 22. The results allow a prediction of likely crash sites, and impact damage likely to the target 101 locations. The target 101 location may be road edge barriers already in place so as to indicate whether they may require upgrading, or the output may be likely impact damage from a vehicle on one of the pathways.

Furthermore, the system 10 also includes a barrier design engine 70 which is hosted on the analytics server 28 and is configured to match vehicle impact data at locations along the one or more pathways with suitable barriers, which have characteristic data stored either locally in databases 24 or 29

The barrier design engine 70 runs a matching algorithm and a disposition algorithm which provides locations and efficient disposition and attitude of the selected barriers. The barrier design engine 70 provides output of the location of the designed barriers on the GUI map which is displayed on the screen of the user mobile device 22. The barrier design engine 70 is connected to the location engine 20 which then provides directions to the location of the selected barrier. The location of suitable barriers may be identified by the barrier design engine 70 and shown in the display screen of the device 22 so as to reduce installation outlay cost and time. The location of barriers may be along pathways using a local minima approach in relation to energy and momentum.

### EXAMPLE

A user is shown on the display of the device 22 a purchase screen for a pack of target 101 assessments and is given authorisation to conduct vehicle impact assessments of a plurality of target 101 locations. An authorisation module 95 is caused to run in the processor of the device 22 or in the web application server 23. The authorisation module 95 causes a screen to be displayed which requires a user to select the size of the pack of target 101 assessments that they would like to purchase: 1, 2, 5, 10, 20, 25, 50, 100.

Upon selection of the pack size, credit card details are entered and the authorisation module 95 provides access to the various location, pathway and modelling engines 20, 30, 40.

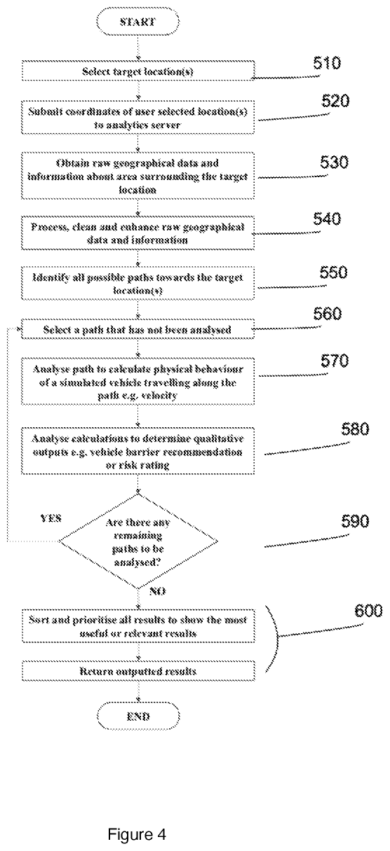

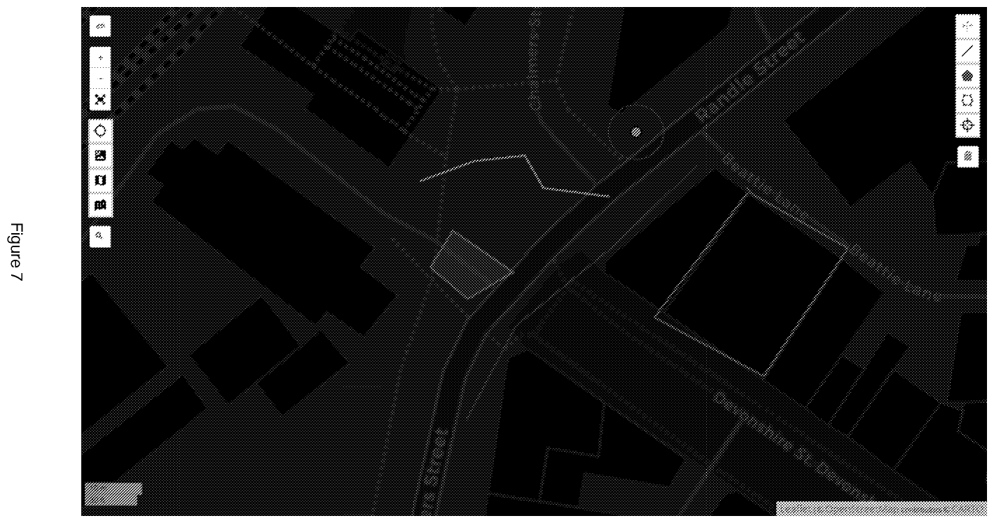

During operation of a preferred embodiment, as shown in FIGS. 3 and 4, a user accesses their user device 22. The user opens a web app on the device 22 (step 500), and an instance of the web app commences, and the location engine 20 calls some supplementary data from onboard GPS engine 97 and web application server 23 via network 99. The web app provides a map on the device display as part of its GUI as shown in FIG. 6. The user identifies a target 101 location to be analysed by touching, mousing or swiping on the display screen (shown in step 510). The user may be standing in the location desired to be modelled, in which case, the GPS location data of device 22, which is a mobile device in this example, will be sent from the GPS engine 97 to the web application server 23 via network 99.

The location engine 20 causes input target 101 location data from the user device 22 to be sent via network 99 to the web application server 23 at step 520. The location engine 20, running in an application on the device 22 and/or web application server 23 (components and data could be shared between device 22 and web application server 23), then calls for and receives data relating to raw road and geographical data and other information from the online mapping database 98 and other online databases 96 (step 530).

In this way, road, geographical, weather, and other data is provided to the device 22 and/or the web application server 23 from the online mapping database 98. The road data is in the form of GPS coordinates.

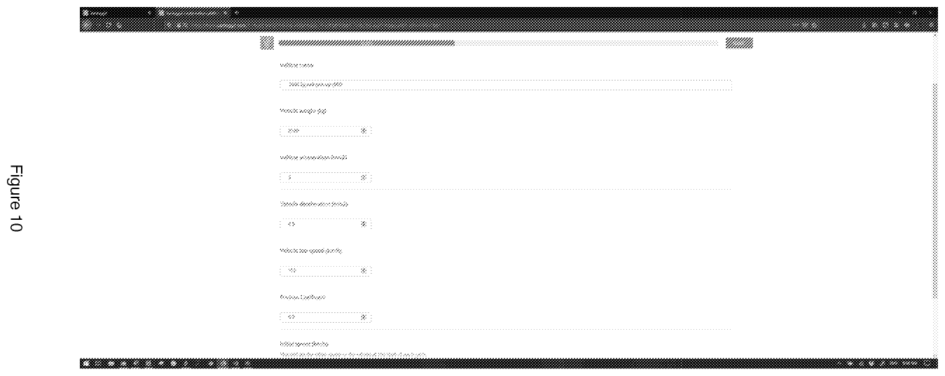

The user is asked to identify the kinds of vehicle that may traverse the path. The user is asked to input various characteristics of the vehicles. This is shown in Screenshot of the UI in FIGS. 9 and 10. In some embodiments, not shown, a user may drag and drop a car, truck or other kind of vehicle onto the pathway and those vehicles will be modelled. The location engine 20 will not allow any vehicles that are too large for the pathway to be modelled, and that occurs by the location engine 20 making an assessment of the path width from the building envelope data provided to the location engine 20.

Enhancing Data for Modelling Accuracy

The pathway engine 30 which is running in the analytics server 28 then calls for the raw road, geographical weather and other data. The pathway engine 30 processes, cleans and enhances at least the raw road data, as well as some geographical data and information, by dividing up the road data and other zones and/or pathways around the target 101 location into a large number of very small elements for numerical processing. In one form, basically the road GPS data is processed so that there is no more than 10 m, 5 m or 2 m, between analysis nodes. The pathway engine 30 autonomously assigns physical characteristic data to the geographical feature data, refining those characteristics with supplementary data from online weather stations, traffic servers, police servers, crime statistics servers and the like, utilising networks 99 and 96. This is shown at step 540.

As a further example of other data, the data from the mapping database 98 includes building location data, and the location engine 20 will transmit this data to the pathway engine 30. The pathway engine 30 is configured to assess the width of the pathways between buildings.

To further clarify, one way of implementing step 540 in more detail is set out below. It is to be understood that, given a road or path which leads to the target 101, the road and geographical data and information detailing that path from the online databases 98 and location engine 20 may contain GPS coordinates of irregular frequency and distribution along that path. To model the behaviour of the vehicle across the entirety of the path in a more complete, accurate and/or detailed manner, it is desirable that the path definition be made further explicit with additional coordinate nodes at regular intervals. The pathway engine 30 intersperses the path definition with greater node density when required to ensure that the coordinate nodes defining the path do not fall below a threshold distance interval i.e. that there is a coordinate node at least every few meters. The minimum distance interval (say, 1, 2, 5, 7, 10 m) is set by the user or by the web application, perhaps depending on processing power available at the web application server 23 or analytics server 30 or network 99 data stream availability on site, to provide a higher or lower resolution of the path. The lower the minimum distance interval, the higher the resolution of coordinate nodes detailing that path.

To further explain: say the web application server 23 is given a pair of nodes i and j from the online mapping database 98. The pathway engine 30 implements the following method to insert extra nodes if nodes i and j are spaced apart from one another beyond a threshold distance.

First, the pathway engine 30 computes the distance and azimuth between i and j. Azimuth is the angle in degrees formed by node j, i and the direction North. If the distance exceeds a set threshold d, eg 5 metres, an extra node k₁ is inserted d metres from i in the direction specified by azimuth.

Next, another node k₂ is inserted d metres from k₁ in the same manner.

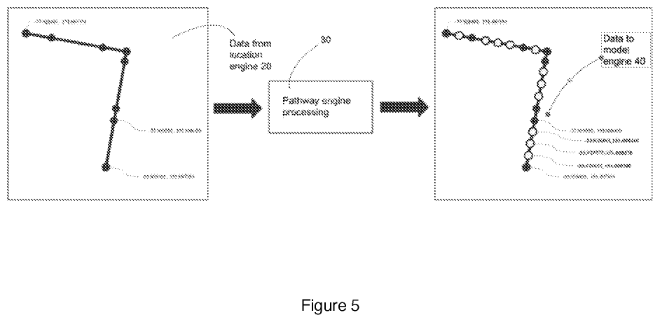

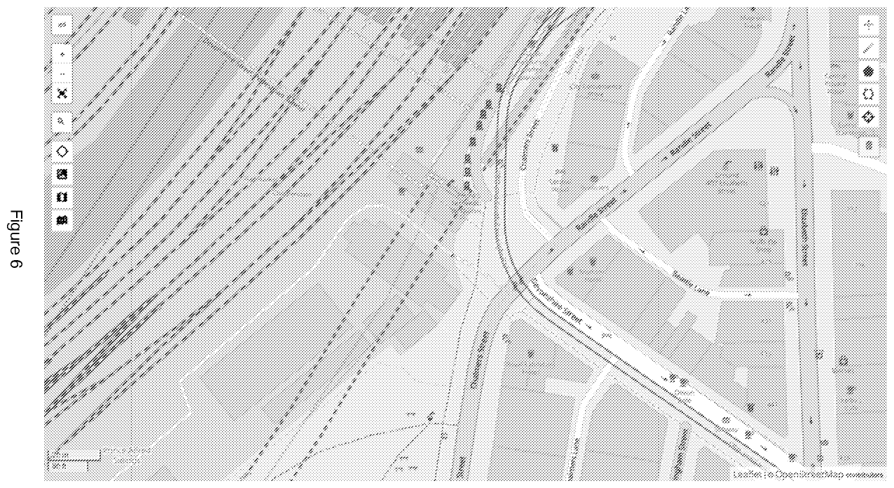

The method repeats until the provision of node kₙ, where the distance between i and kₙ exceeds the distance between i and j. Instead of inserting node kₙ, node j is added on to the end and the process ends. This is shown graphically in FIG. 5.

Generating Vehicle Pathways to Target

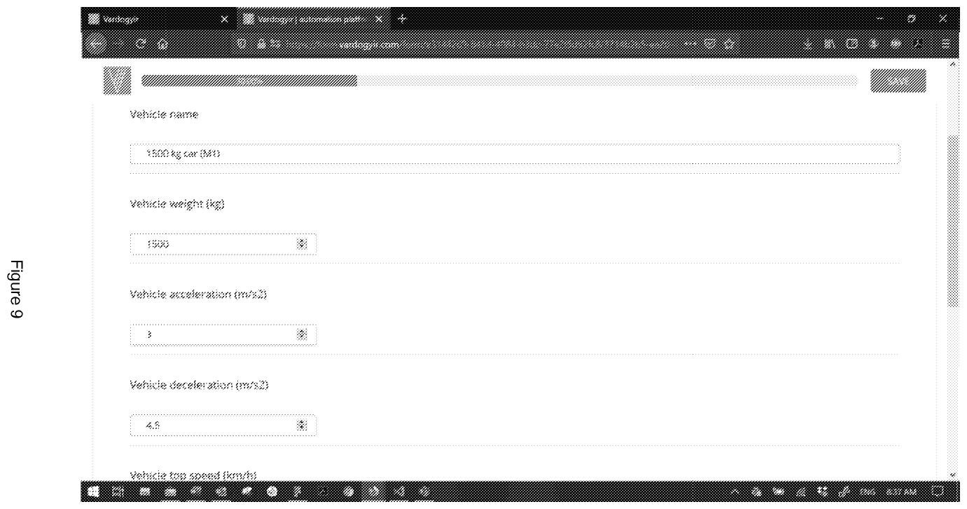

Using the cleaned data, modified data and physical elements, the pathway engine 30 further generates pathway coordinate data relating to one or more potential pathways along which a vehicle may travel from outside the selected area to the target 101 location. The pathway engine 30 essentially identifies cleaned GPS road nodes that are adjacent to one another, even around corners, within a selected radius that may extend out to a radius that is user selected and may default to 100 m, 200 m, 300 m, 400 m, 500 m, 600 m, 700 m, 800 m, 900 m, 1000 m, 2 km, 3 km or more. This is shown at step 550. FIG. 8 shows the UI asking the user to input the desired analysis radius.

At this point the system 10 thus groups pathways from the edge of the radius to the target 101, which extend to the target 101, and therefore has generated a plurality of pathway data sets which represent a plurality of useful pathways which could be used by an aggressive vehicle being driven to the target 101.

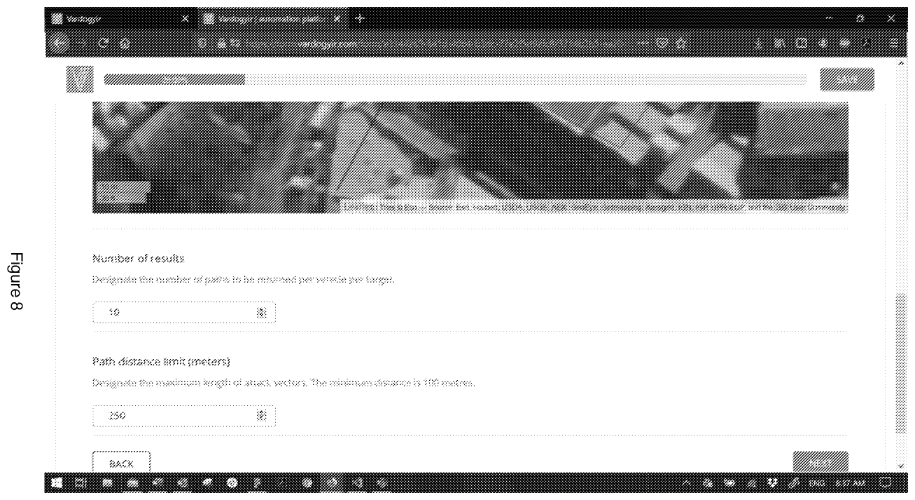

Discussed later in this specification are manual pathways that may be input by the user to supplement the pathway engine 30 effort. The user can be seen inputting manual pathways at 85 in FIG. 7. The user can also be seen inputting manual traffic control devices at 83 in FIG. 7 using tool 91. These control devices are utilised in the formulae to model vehicle behaviour along the pathways to target 101.

Energy Modelling

The modelling engine 40 then selects a pathway coordinate data set for one pathway that has not yet been modelled (step 560) and then, using assigned data either from the user via device 22, and/or from onboard 29 and online databases (using network 96) it assigns vehicle characteristic data such as friction, suspension dynamics, mass, size, speed, acceleration and the like, to one or more proposed vehicles, and iteratively and numerically models a plurality of different vehicle trips along the pathway. It can be seen in FIG. 7 that the user is presented with a vehicle data input screen, and is asked to input various characteristics of the vehicle: mass, acceleration capacity, tyre friction, and the like. That vehicle data is transmitted over the network 99 to the modelling engine 40. The user may be shown the pathways, and asked to input various characteristic data relating to various suitable vehicles for the pathways. For example, the location engine 20 may have recorded that the pathways may be wide enough for a truck, and if so, truck data may be requested. If the pathways are not wide enough for a truck, the user will not be asked for truck data. If the pathways generated by the pathway engine 30 are wide enough for trucks, the user will be asked for truck data.

The modelling engine 40 is intended to simulate a vehicle being driven by a person trying to cause as much damage to the target 101 as possible, with the vehicle under their command. Therefore the maximum available acceleration is assigned to the vehicle, tempered by local conditions, such as terrain and turn radius. Example overarching algorithms are set out below.

A plurality of different vehicle trips are modelled, using different initial speeds, acceleration at different points. and using different vehicles with different characteristics. This is step 570.

In more detail, the modelling engine 40 calculates, at step 570, the velocity of a simulated vehicle from node i to node f. Where node i is the first node in the series, the initial velocity is assumed to be 0, that is, the vehicle begins from a complete stop, though this value can also be substituted for another value. The final velocity of any node becomes the initial velocity for the calculation of the final velocity of the next connecting node. For example, if for a path A to B to C, if the final velocity for the path A to B is 70 km/h, then the initial velocity for the path B to C is 70 km/h.

The formula is v_{f}=\sqrt{vᵢ²+(2ad)}. where
v_{f}=final velocity at node f
vᵢ=initial velocity at node i
a=acceleration of vehicle
d=distance between node i and node f

Acceleration a is derived from the following formula

a=aᵥ+aₛ
Where aᵥ=vehicle acceleration or deceleration in m/s²
aₛ=acceleration or deceleration due to slope in m/s²
Where aₛ=g×(sin(φ)+μ×cos(φ))
g=gravitational constant in m/s²
μ=friction coefficient
φ=angle of slope incline or decline in degrees
If φ represents an incline then
   aₛ will be negative, otherwise a positive value.

The value of aᵥ is a range. Where the maximum value represents maximum vehicle acceleration and minimum value represents maximum deceleration of vehicle brakes.

When a simulated vehicle makes a turn along a path, the turn radius is estimated with the modelling engine 40 using the following formula.

r=(pₐ×θ_{ifj}²)+(p_{b}×θ_{ifj})+p_{c}.
Where r=radius of turn.

pₐ, p_{b} and p_{c} are derived through a linear regression, by fitting the curve radii and curve angle data from a road engineering and design standard such as “A POLICY on GEOMETRIC DESIGN of HIGHWAYS and STREETS 2001” Exhibit 9-19 (reproduced at FIG. 15, and the whole standard being incorporated into this specification by its reference here). The data from these standards which dictate the design and engineering of road turns may be dynamically selected based on the location of the assessment i.e. if the location is in Australia, data from the Australia design standard is used.
θ_{ifj}=angle formed by node i, node f and node j (degrees) where 0≤θ_{ifj}≤180.

The modelling engine 40 attempts to simulate a vehicle that is being driven by a person with an intention to cause as much damage as possible, to the selected target 101 area. The modelling engine 40 assumes that a selected vehicle is being driven as fast as its characteristics will allow. Friction, for example, is a limiting factor when negotiating a turn. Put simplistically, a vehicle will turn or spin or lose control if it takes a corner too fast, and if the vehicle is driven too fast for the conditions, which may involve wet roads, tight turns, oil, negative camber, superelevation deficiency, it may not reach the target 101. Thus, the modelling engine 40 calculates maximum speed for a turn. If a vehicle must make a turn along a path to get to the target 101, the maximum speed at which it can make successfully make that turn without losing control is determined by the weight of the vehicle, the radius of the curve of the turn, and the friction coefficient between the tires of the vehicle and the road it is travelling on.

This value is vᵢ=\sqrt{μrg}

where vₜ=maximum velocity for a turn (m/s)=friction coefficient
g=gravitational constant (9.82 m/s2)
r=radius of the turn (m)

This value is calculated for all node to node paths, and the modelling engine 40 compares the initial velocity at the starting node i with the calculated maximum velocity for the turn, and then takes the lowest of these two values as the velocity for that path.

This Formula assumes that the turn is performed on a flat path and not a banked turn. It may be substituted or modified with other formulas which are appropriate for banked turns where that geographic data can be extracted from databases or provided by the user.

Consider a path with node h, node i, node j and node k: if the angle of the turn (turn 1) formed by node h, node i, node j is small while the angle of the turn (turn 2) formed by node i, node j and node k is large, the vehicle may spin out of control if it traverses turn 1 at maximum possible speed specified by the formula above (para 87).

To remedy this, the system in use will begin deceleration at node i. The rate of deceleration is specified by the range of aᵥ. If the distance between node i and j is insufficient to decelerate to an appropriate speed, then deceleration begins at node h. If distance to node h is insufficient, deceleration will begin one node further back along path. This repeats until sufficient distance for deceleration is achieved.

If this process reaches beginning node of path and distance is still insufficient, then that path is deemed not-traversable by that vehicle.

To further enhance the accuracy of its calculations, the modelling engine 40 can also assess the effect of the simulated vehicle impacting a surface at a particular angle. As a vehicle approaches a target 101, it will do so at a particular angle, and this influences the amount of energy transferred between the vehicle and the target 101. The energy transfer is maximised when a vehicle is perpendicular to the target 101. The formula set out below is used to determine the reduction in speed that results from the simulated vehicle approaching a target 101 from an angle. The formula is v_{P}=v sin θ

The load transfer of an impacting vehicle is reduced if the angle of impact is less than 90 degrees to a barrier. To allow for a more accurate calculation of this reduction in velocity, the user must submit information to the user device 22 about the direction of the target 101 location being assessed. The user device 22 will transfer the information to the modelling engine via network 99.

The following formula is used by the modelling engine 40 to determine the momentum of the simulated vehicle at node f when travelling from node i to node f. The formula is \vec{p}=m\vec{v_{f}}.
where p=maximum velocity for a turn (m/s)
m=mass of the vehicle (kg)
v_{f}=velocity reached at node f (m/s)

The following formula is used by the modelling engine 40 to determine the kinetic energy of the simulated vehicle at node f when travelling from node i to node f. The formula is Eₖ=½ mvⱼ².
where Eₖ=kinetic energy (Joule)
m=mass of the vehicle (kg)
v_{f}=velocity reached at node f (m/s)

The barrier design engine 70 then matches the impact and momentum of various vehicles at various points along the pathway and identifies the best location and size for the most efficient barrier to inhibit progress towards the target 101 location. It may be that the best barrier is at some point other than the point closest to the target 101, or even at the slowest point, since that may require the least financial and mass outlay. The most efficient barrier may be angled in an advantageous way, which the barrier design engine 70, coupled with the modelling engine 40, may be able to identify.

Outputs of the modelling engine 40 are the energy and/or momentum and/or velocity of the vehicle at each node along each pathway to the target 101. This is a lot of data, so the modelling engine 40 produces a qualitative analysis by generating three categories of vehicle impact consequence on the target 101. The three vehicle impact consequence categories are:
minor;
moderate;
severe.

The three vehicle impact categories are assigned by an assessment of the momentum mv of the vehicle, such that minor is equal to or under 25 000 Ns; moderate is between 25 000 and 95 000 Ns; and Severe is over 95 000 Ns. This is shown in Table 1 below.

TABLE 1
Consequence rating for possible impacts
on target 101 for each pathway.

| | Minimum value | Maximum value |
|---|---|---|
| Consequence rating | (newton seconds) | (newton seconds) |
| Severe | >95,000 | ≤25,000 |
| Moderate | >25,000 | ≤95,000 |
| Minor | 0 | ≤25,000 |

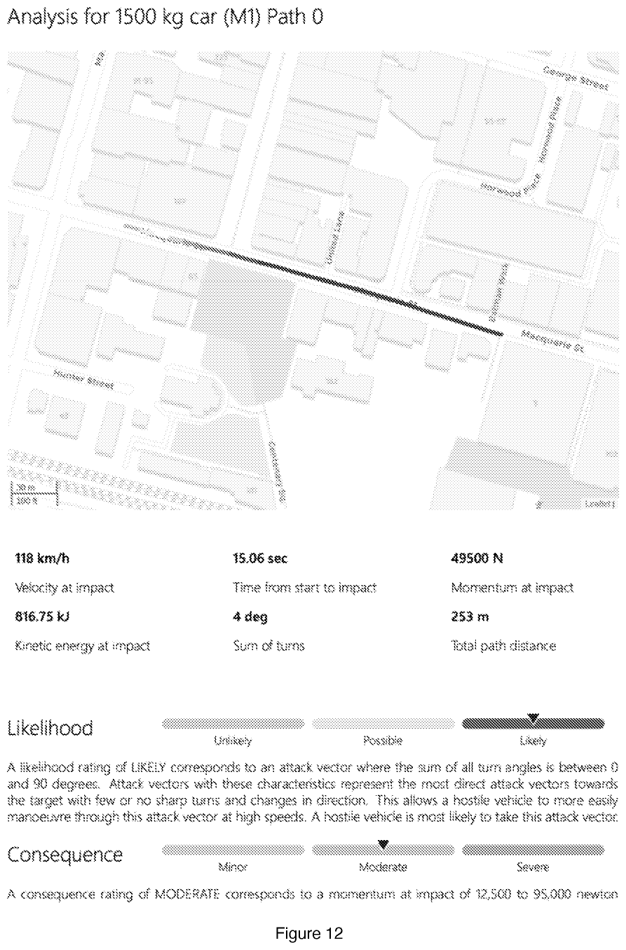

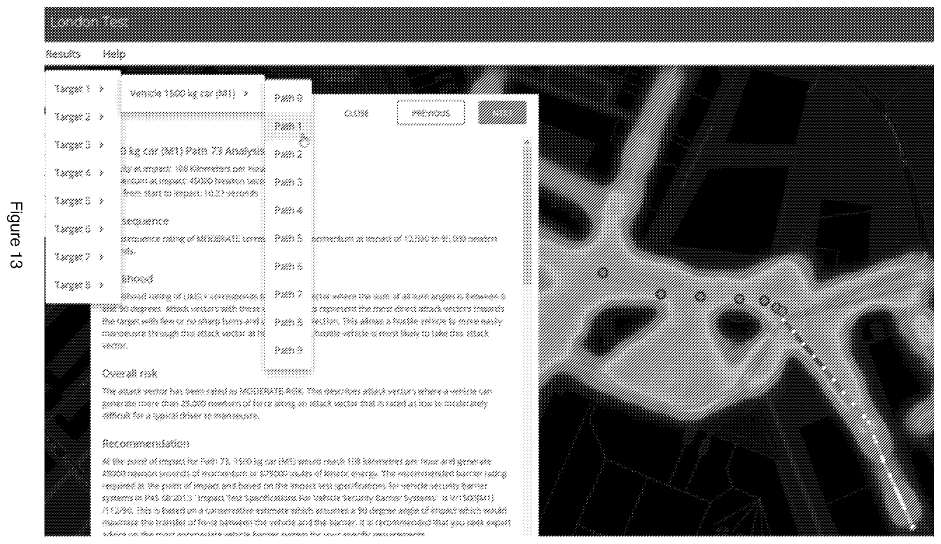

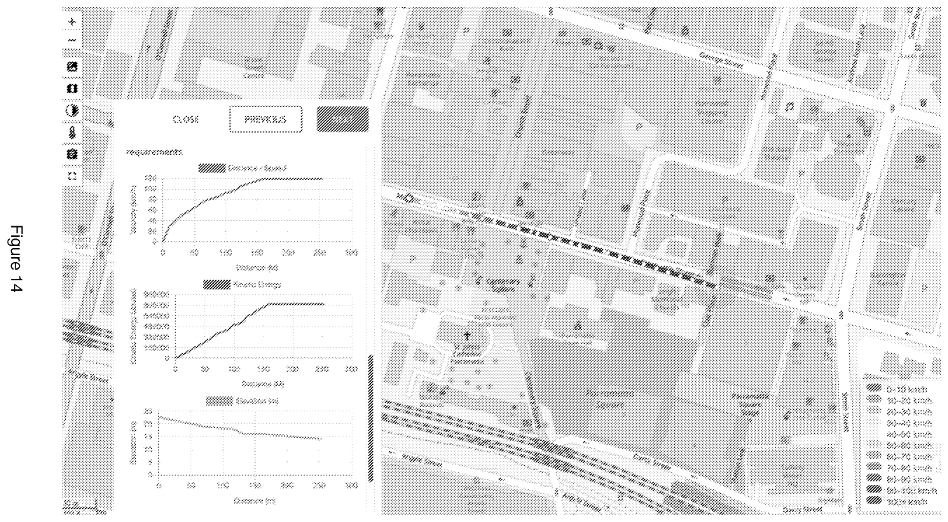

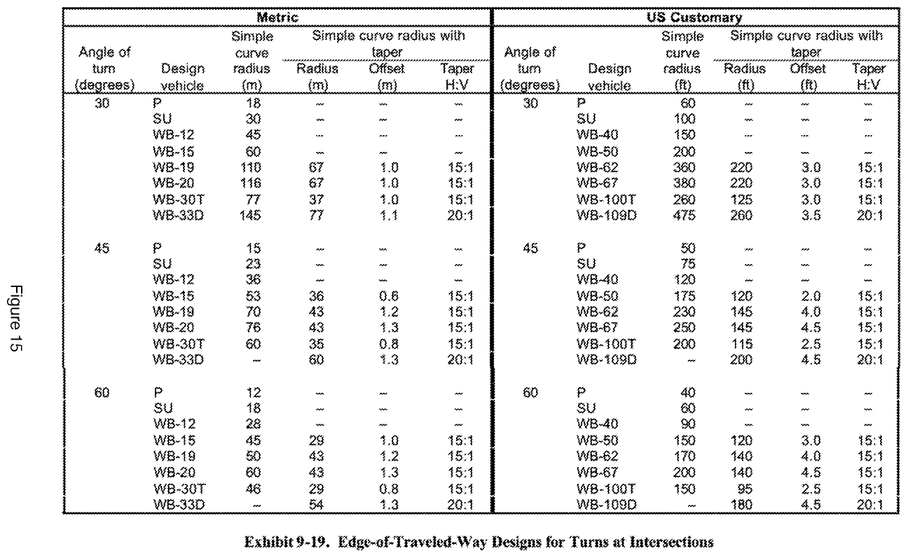

The modelling engine 40 produces a likelihood matrix shown in FIG. 12. To produce this matrix, the modelling engine 40 receives analysed data from the modelling engine 40. The modelling engine 40 is configured to assess the difficulty of any of the traversable pathways. The algorithm used is to add the angles of turns for a path together. The principle here is that the more complex and difficult a path is to navigate, due to high number of sharp turns or changes in direction, the lower the likelihood that the path will be used or taken relative to other simpler and less challenging paths. The modelling engine 40 creates three categories of pathway likelihood based on the total twist of the route: unlikely, possible and most likely. If the sum of the angles of the path turns to the target 101 to reach a damaging terminal energy or momentum is between 0 degrees and 90 degrees, that path is assigned a status of most likely. If the sum of the angles of the path turns to the target 101 is between 90 and 180 degrees, that path is possible. If the sum of the angles of the path turns to the target 101 is greater than 180 degrees, then that path is relatively least likely.

TABLE 2
categorisation of relative pathway likelihood to target 101

| | Minimum value | Maximum value |
|---|---|---|
| Likelihood rating | (sum of angles) | (sum of angles) |
| Likely | >0° | ≤90° |
| Possible | >90° | ≤180° |
| Unlikely | >180° | |

The barrier design engine 70 then produces a risk mitigation matrix. The risk mitigation matrix, an example of which is shown in Table 3, is a matrix which sets out the likelihood and consequence ratings on the two axes.

This analysis can be very useful since most resources on barriers may be expended on the most likely pathways and the possible pathways to the target 101, while the least likely pathways may be provided with relatively fewer barriers, or a different kind of barrier. This is step 580.

Further, the barrier design engine 70 requests data from online 97 or onboard databases 27 to assess barrier specification for traversible pathways, prioritising the High Risk pathways. The energy and/or velocity and/or momentum of any of the vehicles input by the user is compared in a lookup table to assess the kind of barrier that is required to protect a target 101 from attack.

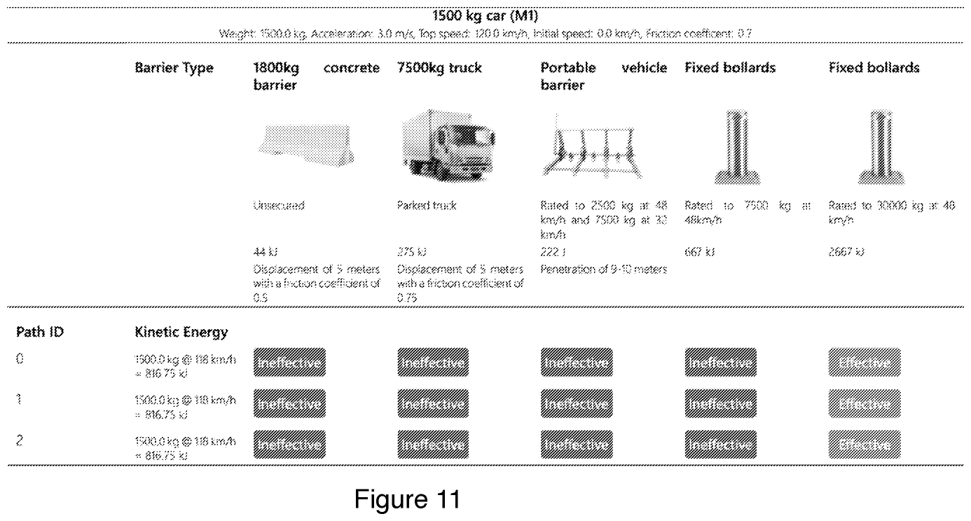

A table is produced with solutions for mitigating damage to the target 101. The table is set out in FIG. 11. FIG. 11 shows the pathway name, and inbound vehicle type and selected characteristics, and five types of barrier which may be selected, and their effectiveness against the vehicle. In the example shown, a 1500 kg vehicle with top speed of 120 km/h, friction coefficient of 0.7, and initial speed of 0 km/h, moving along pathways 0, 1 and 2, can be stopped at the target 101 by Fixed bollards, but not portable barriers, parked trucks or concrete barriers.

TABLE 3
risk mitigation matrix for the identified pathways

| | Minor | Moderate | Severe |
|---|---|---|---|
| Likely | Low Risk | Medium Risk | High Risk |
| Possible | Low Risk | Medium risk | Medium Risk |
| Unlikely | Low Risk | Low Risk | Low Risk |

One very useful feature of the analysis engine 40 and barrier design engine 70 is that each node may be analysed along each pathway. What that allows is a placement of a more economical barrier, even, say, at a selected angle, further up the pathway, further from the target 101. In cases where there are no suitable barriers because of a straight, long, run in front of the target 101, this can be useful. What the barrier design engine 70 does to effect such a barrier placement is analyse the energy or velocity or momentum along a high risk pathway (or other, lower risk pathway for that matter) and seek a local energy or velocity or momentum minima in the nodes proximal the target 101. If necessary, higher weightings can be placed on the nodes closer to the target 101 to reduce the need for placing barriers on public or neighbouring land, which would require additional permits and the like, and more expense in investigating underground and other impediments to barrier installation.

The barrier design engine 70 can connect via API to a barrier supplier and check availability by querying SKU data with the supplier and the design engine 70 may ask user to confirm the order of the selected number of selected barriers. Alternatively the barrier design engine 70 may provide a PDF report, and/or photographs or part numbers, or descriptions of the selected barriers and their number, so that a user can input the barriers into their search engine on their device 22, or into their image searching function in their browser, so that they may order themselves.

Another useful feature of the system 10 is that the user can manually input pathways. This can be because of some local deficiency in information or GPS path coordinates for some pathway for example a footpath, sidewalk, staircase, tree, or other design element. The location engine 20 can receive input from a user on GPS coordinates of the

The user can incorporate a design element 93 into the analysis by selecting the design element tool button shown at item 91 on the user interface shown at 92 in FIGS. 6 and 7. The effect of the design element 93 on the vehicle energy is taken into account by the modelling engine 40. For example, there may be a chicane, a speed bump, or other traffic device.

At step 590, the modelling engine 40 then returns to the pathway engine 20 to select another available pathway to the target 101 which has not been modelled.

At step 600, the modelling engine 40 then overlays onto the GUI of the user device 22 the most relevant or useful results, which includes the pathways on the map, and the efficient placement, including location and angle of the barriers.

A barrier placement module 80 may also be included which provides for a user to use their mobile device to identify the location of the barriers. The barrier placement module is connected via API to Google maps or Apple maps or other suitable mapping application and reduces the need for a barrier deployment team to read maps. Instead, the barrier placement team merely listens to instructions on their phone to find the location of the proposed barrier. For events, this is very useful since the barriers are often placed only temporarily and then they are taken away after the event to another location in preparation for another event.

### CLARIFICATIONS

Modifications and improvements to the invention will be readily apparent to those skilled in the art. Such modifications and improvements are intended to be within the scope of this invention.

1.-44. (canceled)

45. A method of modelling momentum of vehicles inbound to a target location, the method including the steps of:
receiving location data into a computer processing system, which relates to a target location relevant to vehicle travel;
generating pathway data in a computer processing system, relating to one or more vehicle pathways to the target location from adjacent areas,
generating modelling data in a computer processing system relating to momentum of vehicles travelling along the one or more pathways to the target location;
displaying on a computing device the output of the modelling data.

46. The method in accordance with claim 45, further including the step of receiving in the computer processing system road and other data environmental data from online databases relating to the target location.

47. The method in accordance with claim 45, further including the step of receiving building envelope data in the computer processing system, to assess pathway width and other road characteristic data from online and local databases.

48. The method in accordance with claim 45, further including the step of receiving in the computer processing system additional road node data on any pathway to the target, wherein the road nodes are no more than a selected distance apart.

49. The method in accordance with claim 48, further including the step of receiving from a user into the computer processing system a selected road node separation distance.

50. The method in accordance with claim 45, further including the step of using an iterative process to process in the computer processing system the distance and azimuth between two nodes i and j, wherein if the distance between two nodes i and j exceeds the set threshold d, an extra node k₁ is inserted d metres from i in the direction specified by the azimuth.

51. The method in accordance with claim 50, further including the step of iterating in the computer processing system the insertion of new nodes until the provision of node kₙ, such that the distance between i and kₙ exceeds the distance between i and j.

52. The method in accordance with claim 45, further including the step of identifying cleaned GPS road nodes that are adjacent to one another, to generate one or more road node pathways to the target.

53. The method in accordance with claim 45, further including the step of receiving into the computer processor a radius around the target for analysis.

54. The method in accordance with claim 53, further including the step of generating pathways to the target within the selected radius.

55. The method in accordance with claim 45, further including the step of receiving into the computer processing system one or more user-input manual pathways to supplement the pathway generation step.

56. The method in accordance with claim 45, further including the step of manually inputting into the computer processing system one or more traffic control devices onto a generated pathway using a device insertion tool on a GUI disposed on a display.

57. The method in accordance with claim 45, further including the step of receiving into the computer processing system, vehicle characteristic data either from a user or a database for analysis and prediction of vehicle behavior along one or more pathways to the target.

58. The method in accordance with claim 45, further including the step of selecting with the computer processing system a pathway coordinate data set for one pathway and then, using the vehicle characteristic data, numerically modelling a plurality of different vehicle trips along the pathway to the target.

59. The method in accordance with claim 45, further including the step of estimating in the computer processing system a radius of a turn based on the following formula:
r=(pₐ×θ_{ifj}²)+(p_{b}×θ_{ifj})+p_{c}
Where r=radius of turn, and pₐ, p_{b} and p_{c} are derived using a linear regression and
θ_{ifj}=angle formed by a first node i, a final node f and node j (degrees) where 0≤θ_{ifj}≤180.

60. The method in accordance with claim 59, wherein the linear regression involves fitting the curve radii and curve angle data from a road engineering and design standard to select a maximum turn radius.

61. The method in accordance with claim 45, further including the step of calculating in the computer processing system the maximum speed for a turn on the pathway.

62. The method in accordance with claim 45, further including the step of recording in the processor the maximum velocity value for all node-to-node paths, comparing the initial velocity at a starting node i with the calculated maximum velocity for the turn, and then recording in the computer processing system the lower of these two values as the maximum velocity for that path.

63. The method in accordance with claim 45, further including the step of requesting data from a lookup table in an online or onboard database to select barrier specification for traversible pathways.

64. The method in accordance with claim 63, further including the step of comparing in the lookup table the energy and/or velocity and/or momentum of any of the vehicles on any of the nodes to specify the kind of barrier that is required to protect the target from attack.
